(19) United States
(12) Patent Application Publication
(10) Pub. No.: US 2020/0094652 A1
(43) Pub. Date: Mar. 26, 2020

(54) HVAC Temperature Control System

(71) Applicant: DENSO International America, Inc., Southfield, MI (US)

(72) Inventor: Rajeev SHARMA, Troy, MI (US)

(21) Appl. No.: 16/136,410

(22) Filed: Sep. 20, 2018

(51) Int. Cl. B60H 1/14; B60H 1/00; B60H 1/32; B60H 3/02

(52) U.S. Cl. CPC B60H 1/143; B60H 1/00328; B60H 1/00742; B60H 2001/00942; B60H 1/323; B60H 3/024; B60H 1/00885

(57) ABSTRACT

A heating, ventilation, and air conditioning (HVAC) system for a vehicle. The HVAC system includes an HVAC case. A first heat exchanger is within the HVAC case along a first airflow path defined by the HVAC case directing airflow to a driver side of the vehicle. A second heat exchanger is within the HVAC case along a second airflow path defined by the HVAC case directing airflow to a passenger side of the vehicle. Varying flowrate of heating medium through the first heat exchanger varies temperature of airflow to the driver side of the vehicle, and varying flowrate of heating medium through the second heat exchanger varies temperature of airflow to the passenger side of the vehicle.

### FIELD

The present disclosure relates to a heating, ventilation, and air conditioning (HVAC) temperature control system for a vehicle.

### BACKGROUND

This section provides background information related to the present disclosure, which is not necessarily prior art.

With reference to FIGS. 1A and 1B, a prior art heating, ventilation, and air-conditioning (HVAC) system is illustrated at reference numeral 10′. The HVAC system 10′ generally includes an HVAC case 12′ and a blower case 20′. The blower case 20′ generates airflow that passes through and out of the HVAC case 12′. The HVAC case 12′ defines a first airflow path 14A′ and a second airflow path 14B′. The HVAC system 10′ is a vehicle HVAC system. When installed in a vehicle, the first airflow path 14A′ directs airflow to a driver side of the vehicle, and the second airflow path 14B′ directs airflow to a passenger side of the vehicle.

The HVAC system 10′ further includes a heat exchanger 30′. The heat exchanger 30′ extends across each one of the first airflow path 14A′ and the second airflow path 14B′ to warm airflow flowing from the HVAC case 12′. With particular reference to FIG. 1B, the HVAC case 12′ further includes an evaporator 40′, a first airflow control door 50A′, and a second airflow control door 50B′. The first airflow control door 50A′ is aligned with the first airflow path 14A′, and is movable to control the flowrate of airflow through the first airflow path 14A′. The second airflow control door 50B′ is aligned with the second airflow path 14B′, and is movable to control the flowrate of airflow through the second airflow path 14B′.

The temperature of the heat exchanger 30′ is uniform across the length thereof. To increase the temperature of airflow flowing through the first airflow path 14A′ and subsequently to the driver side of the vehicle, the first airflow control door 50A′ is rotated to allow more airflow through the heat exchanger 30′. To reduce the temperature of airflow flowing through the first airflow path 14A′ and subsequently to the driver side of the vehicle, the first airflow control door 50A′ is rotated to reduce the amount of airflow flowing through the heat exchanger 30′. Similarly and with respect to the passenger side, to increase the temperature of airflow flowing through the second airflow path 14B′ and subsequently to the passenger side of the vehicle, the second airflow control door 50B′ is rotated to allow more airflow through the heat exchanger 30′. To reduce the temperature of airflow flowing through the second airflow path 14B′ and subsequently to the passenger side of the vehicle, the second airflow control door 50B′ is rotated to reduce the amount of airflow flowing through the heat exchanger 30′.

While the HVAC system 10′ is suitable for its intended use, it is subject to improvement. For example, controlling the temperature of airflow through the first and second airflow paths 14A′ and 14B′ using the two separate first and second airflow control doors 50A′ and 50B′ undesirably increases the size of the HVAC case 12. Furthermore, the first and second airflow control doors 50A′ and 50B′ undesirably complicate the operation and manufacturing of the HVAC system 10′, and in rare instances are subject to failure. The present disclosure provides for an improved HVAC system that provides numerous advantages as set forth herein, and as one skilled in the art will appreciate.

### SUMMARY

This section provides a general summary of the disclosure, and is not a comprehensive disclosure of its full scope or all of its features.

A heating, ventilation, and air conditioning (HVAC) system for a vehicle. The HVAC system includes an HVAC case. A first heat exchanger is within the HVAC case along a first airflow path defined by the HVAC case directing airflow to a driver side of the vehicle. A second heat exchanger is within the HVAC case along a second airflow path defined by the HVAC case directing airflow to a passenger side of the vehicle. Varying flowrate of heating medium through the first heat exchanger varies temperature of airflow to the driver side of the vehicle, and varying flowrate of heating medium through the second heat exchanger varies temperature of airflow to the passenger side of the vehicle.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of select embodiments and not all possible implementations, and are not intended to limit the scope of the present disclosure.

FIG. 1A illustrates a prior art HVAC system including an HVAC case with a single heat exchanger;

FIG. 1B is a cross-sectional view of the prior art HVAC case of FIG. 1 A taken along line 1B-1B of FIG. 1A;

FIG. 2A illustrates an HVAC system in accordance with the present disclosure, the HVAC system includes an HVAC case with two heat exchangers, a first heat exchanger for a driver side and a second heat exchanger for a passenger side of a vehicle;

FIG. 2B is a cross-sectional view of the HVAC case of FIG. 2A taken along line 2B-2B of FIG. 2A;

FIG. 3 illustrates a control valve of the HVAC system of FIG. 2A for controlling flow of heating medium through the first heat exchanger and the second heat exchanger; and

FIG. 4 illustrates a first control valve for controlling flow of heating medium through the first heat exchanger, and a second control valve for controlling flow of heating medium through the second heat exchanger.

Corresponding reference numerals indicate corresponding parts throughout the several views of the drawings.

### DETAILED DESCRIPTION

Example embodiments will now be described more fully with reference to the accompanying drawings.

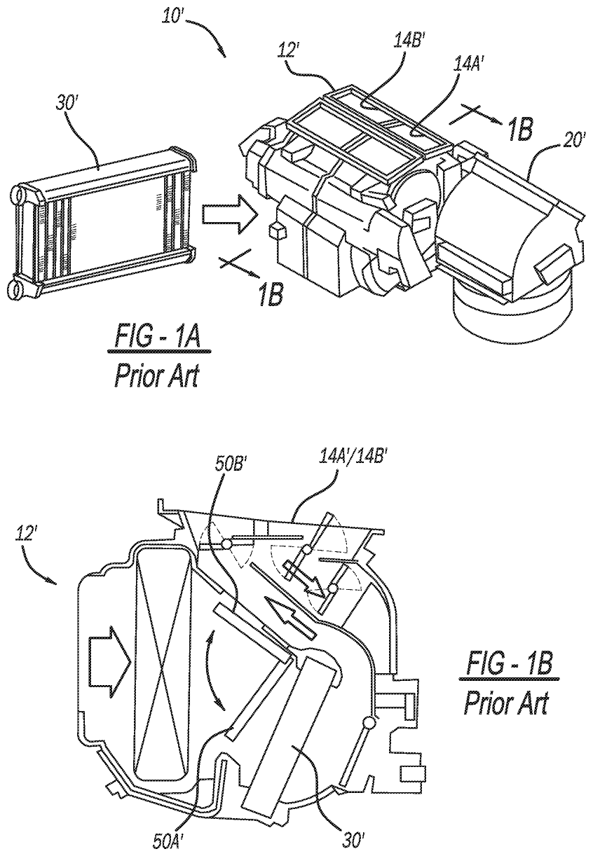

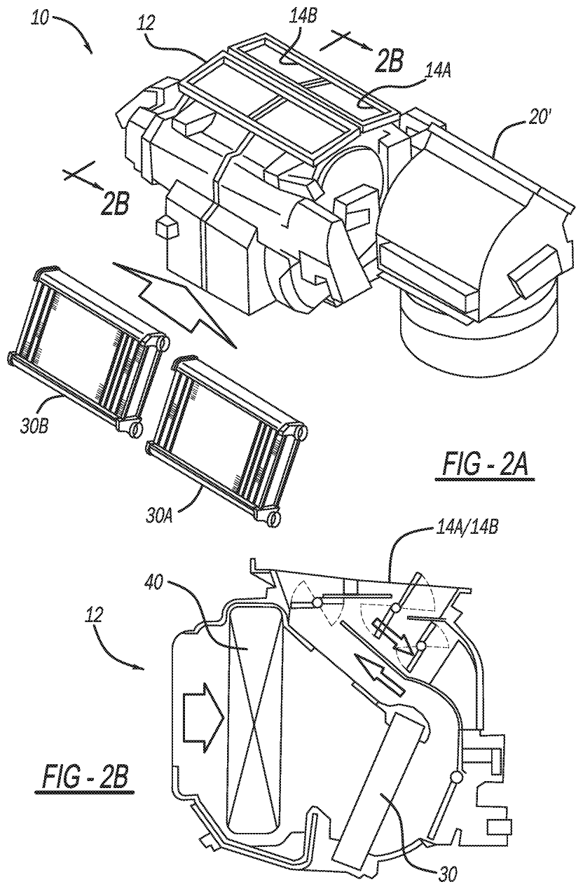

FIG. 1 illustrates a heating, ventilation, and air conditioning (HVAC) system 10 in accordance with the present disclosure. The HVAC system 10 may be configured for use with any suitable vehicle. Exemplary vehicles include any suitable passenger vehicle, mass transit vehicle, recreational vehicle, utility vehicle, construction vehicle/equipment, military vehicle/equipment, watercraft, aircraft, etc. The HVAC system 10 may also be configured for use with any suitable non-vehicular application as well.

The HVAC system 10 generally includes an HVAC case 12, and a blower case 20. The blower case 20 generates airflow through and out of the HVAC case 12. The HVAC case 12 defines a first airflow path 14A and a second airflow path 14B. When installed in an exemplary vehicle, the first airflow path 14A directs airflow to a driver side of the vehicle, and the second airflow path 14B directs airflow to a passenger side of the vehicle.

The HVAC case 12 further includes a first heat exchanger 30A and a second heat exchanger 30B. The first heat exchanger 30A is arranged within the first airflow path 14A to heat airflow flowing through the first airflow path 14A, and ultimately to the driver side of the vehicle. The second heat exchanger 30B is arranged in the second airflow path 14B to heat airflow flowing through the second airflow path 14B, and ultimately to the passenger side of the vehicle. The first heat exchanger 30A and the second heat exchanger 30B may be any heat exchanger suitable for heating airflow. For example, the first and second heat exchangers 30A and 30B may be condensers or heater cores. Any suitable heating medium is circulated through the first and second heater cores 30A and 30B, such as any suitable refrigerant or water. The HVAC case 12 further optionally includes an evaporator 40. The evaporator 40 cools airflow flowing into the HVAC case 12 from the blower case 20.

Temperature of airflow flowing through the first airflow path 14A to the driver side of the vehicle, and temperature of airflow flowing through the second airflow path 14B to the passenger side of the vehicle, is controlled by varying the flowrate of the heating medium through the first and second heat exchangers 30A and 30B. The temperature is also controlled by activating or deactivating the evaporator 40. With respect to controlling the flowrate of the heating medium, any suitable control valve may be used.

For example and as illustrated in FIG. 3, a single control valve 60 controls the amount of heating medium flowing to the first heat exchanger 30A and to the second heat exchanger 30B from inlet line 62. After the heating medium has passed through the first and/or second heat exchangers 30A and 30B, the heating medium flows through outlet line 64 and is recirculated to the inlet line 62, such as through an engine of the vehicle where the heating medium is heated. Thus arranging the control valve 60 to increase the flowrate of the heating medium through the first heat exchanger 30A will increase the temperature of airflow flowing through the first airflow path 14A to the driver side of the vehicle, and decreasing the flowrate of the heating medium through the first heat exchanger 30A will decrease the temperature of airflow flowing through the first airflow path 14A to the driver side of the vehicle. Similarly, arranging the control valve 60 to increase the flowrate of the heating medium through the second heat exchanger 30B will increase the temperature of airflow flowing through the second airflow path 14B to the passenger side of the vehicle, and decreasing the flowrate of the heating medium through the second heat exchanger 30B will decrease the temperature of airflow flowing through the second airflow path 14B to the passenger side of the vehicle.

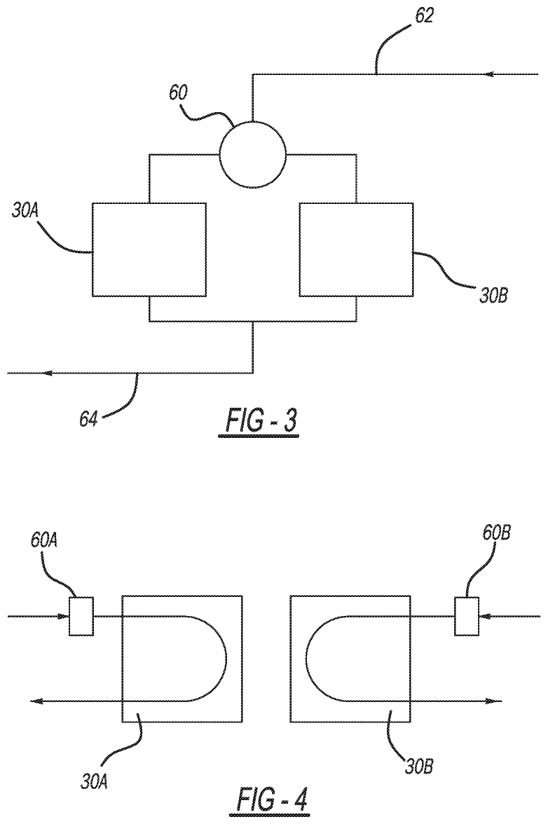

With reference to FIG. 4, instead of having a single control valve 60 as illustrated in FIG. 3, a first control valve 60A and a second valve 60B may be included. The first control valve 60A is dedicated to controlling the flowrate of heating medium through only the first heat exchanger 30A. The second control valve 60B is dedicated to controlling the flowrate of heating medium through only the second heat exchanger 30B.

The present disclosure thus advantageously eliminates the need for airflow control doors 50A′ and 50B′, which in the prior art example of FIGS. 1A and 1B are required to vary airflow temperature by controlling the amount of hot and cold airflow that is mixed within the HVAC case 12′. Eliminating the airflow control doors 50A′ and 50B′ advantageously eliminates manufacturing and operational complexities of the HVAC system 10, improves reliability, and allows the size of the HVAC case 12 to be reduced.

The present disclosure further provides advantages with respect to dehumidification of the passenger cabin. When the HVAC system 10 is operated in a dehumidification mode, and the first and second heat exchangers 30A and 30B are condensers with refrigerant flowing therethrough as the heating medium, air cooled by the evaporator 40 is reheated by the heat exchangers 30A and 30B to a desired temperature with minimum energy lost to the atmosphere. This saves energy and increases driving range, particularly with electric or PHEV vehicles. Thus, when refrigerant is used as the heating medium, the same energy can be used to reheat the air in case of dehumidification.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A heating, ventilation, and air conditioning (HVAC) system for a vehicle comprising:
an HVAC case;
a first heat exchanger within the HVAC case along a first airflow path defined by the HVAC case directing airflow to a driver side of the vehicle; and
a second heat exchanger within the HVAC case along a second airflow path defined by the HVAC case directing airflow to a passenger side of the vehicle;
wherein varying flowrate of heating medium through the first heat exchanger varies temperature of airflow to the driver side of the vehicle, and varying flowrate of heating medium through the second heat exchanger varies temperature of airflow to the passenger side of the vehicle.

2. The HVAC system of claim 1, wherein the first heat exchanger is a first condenser, and the second heat exchanger is a second condenser.

3. The HVAC system of claim 1, wherein the first heat exchanger is a first heater core, and the second heat exchanger is a second heater core.

4. The HVAC system of claim 1, wherein the heating medium is refrigerant.

5. The HVAC system of claim 1, wherein the heating medium includes water.

6. The HVAC system of claim 1, further comprising a control valve that controls flowrate of heating medium to both the first heat exchanger and the second heat exchanger.

7. The HVAC system of claim 1, further comprising a first valve that controls flowrate of heating medium to the first heat exchanger, and a second valve that controls flowrate of heating medium to the second heat exchanger.

8. The HVAC system of claim 1, wherein temperature of airflow to the driver side of the vehicle and temperature of airflow to the passenger side of the vehicle is varied without actuating a door of the HVAC case.

9. The HVAC system of claim 1, further comprising an evaporator within the HVAC case.

10. The HVAC system of claim 9, wherein:
the heating medium is refrigerant; and
at least one of the first heat exchanger and the second heat exchanger heats airflow cooled by the evaporator to dehumidify airflow through the HVAC case, thereby conserving energy and increasing vehicle driving range.

11. A heating, ventilation, and air conditioning (HVAC) system for a vehicle comprising:
an HVAC case;
a blower case including a blower generating airflow through the HVAC case;
a first heat exchanger within the HVAC case along a first airflow path defined by the HVAC case directing airflow to a driver side of the vehicle; and
a second heat exchanger within the HVAC case along a second airflow path defined by the HVAC case directing airflow to a passenger side of the vehicle; and
at least one control valve controlling flow of heating medium to the first heat exchanger and the second heat exchanger;
wherein arranging the at least one control valve to increase flowrate of heating medium through the first heat exchanger increases temperature of airflow to the driver side of the vehicle, and arranging the at least one control valve to decrease flowrate of heating medium through the first heat exchanger decreases temperature of airflow to the driver side of the vehicle; and
wherein arranging the at least one control valve to increase flowrate of heating medium through the second heat exchanger increases temperature of airflow to the passenger side of the vehicle, and arranging the at least one control valve to decrease flowrate of heating medium through the second heat exchanger decreases temperature of airflow to the passenger side of the vehicle.

12. The HVAC system of claim 11, wherein the first heat exchanger is a first condenser, and the second heat exchanger is a second condenser.

13. The HVAC system of claim 11, wherein the first heat exchanger is a first heater core, and the second heat exchanger is a second heater core.

14. The HVAC system of claim 11, wherein the heating medium is refrigerant.

15. The HVAC system of claim 11, wherein the heating medium includes water.

16. The HVAC system of claim 11, wherein the at least one control valve includes a first valve that controls flowrate of heating medium to the first heat exchanger, and a second valve that controls flowrate of heating medium to the second heat exchanger.

17. The HVAC system of claim 11, wherein temperature of airflow of the driver side of the vehicle and temperature of airflow to the passenger side of the vehicle is varied without actuating a door of the HVAC case.

18. The HVAC system of claim 11, further comprising an evaporator within the HVAC case.

19. The HVAC system of claim 18, wherein:
the heating medium is refrigerant; and
at least one of the first heat exchanger and the second heat exchanger heats airflow cooled by the evaporator to dehumidify airflow through the HVAC case, thereby conserving energy and increasing vehicle driving range.
